(19) United States
(12) Patent Application Publication
(10) Pub. No.: US 2010/0317434 A1
(43) Pub. Date: Dec. 16, 2010

(54) Method and Apparatus for Gaming Controller with Electroluminescence

(76) Inventors: Aaron J. Golle, Shakopee, MN (US); Stephen L. Spurgeon, Boulder, CO (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/816,946

(22) Filed: Jun. 16, 2010

Related U.S. Application Data
(60) Provisional application No. 61/187,602, filed on Jun. 16, 2009.

(51) Int. Cl. G06F 17/00

(52) U.S. Cl. 463/31; 463/37

(57) ABSTRACT

A method of an aspect includes communicating a signal associated with user performance from a gaming console to a gaming controller, and controlling an EL lamp coupled to the gaming controller according to the signal. The gaming controller of an aspect may have a decoration through which light from the EL lamp is to be transmitted. The decoration of an aspect may be printed with an ink jet printer such as an ultraviolet (UV) printer.

### RELATED APPLICATIONS

This application claims priority from U.S. Provisional Patent Application 61/187,602, entitled “METHOD AND APPARATUS FOR GAMING CONTROLLER WITH ELECTROLUMINESCENCE”, filed on Jun. 16, 2009, by Aaron J. Golle. U.S. The Provisional Patent Application 61/187,602 is hereby incorporated herein by this reference. This patent application claims priority from U.S. Provisional Patent Application No. 61/179,631 entitled “DECORATING GUITARS”, filed on May 19, 2009, by Stephen L. Spurgeon. U.S. Provisional Patent Application No. 61/179,631 is hereby incorporated herein by reference in its entirety.

### BACKGROUND

1. Field

Embodiments relate to game controllers. In particular, embodiments relate to game controllers to be illuminated by an electroluminescent light or other light.

2. Background Information

Game controllers, including guitar video game controllers, are known. Electroluminescent devices are also known.

### BRIEF DESCRIPTION OF THE SEVERAL VIEWS OF THE DRAWINGS

The invention may best be understood by referring to the following description and accompanying drawings that are used to illustrate embodiments of the invention. In the drawings:

FIG. 1 shows a cross section diagram of a gaming controller according to an embodiment.

FIG. 2 shows an isometric view of a gaming controller according to an embodiment.

FIG. 3 shows an isometric view of a gaming controller according to an embodiment.

FIG. 4 shows a front view of a gaming controller according to an embodiment.

FIG. 5 shows an isometric view of a gaming controller according to an embodiment.

FIG. 6 shows a gaming controller and a console, according to an embodiment.

FIG. 7 shows a side view of a guitar, according to an embodiment.

FIG. 8 shows a guitar and an EL faceplate, according to an embodiment.

FIG. 9 shows a guitar, EL lamps and a power pack, according to several embodiments.

FIG. 10 shows a guitar in a cradle, according to an embodiment.

FIG. 11 shows a guitar and a cradle, according to an embodiment.

FIG. 12 shows a sword with EL, according to an embodiment.

FIG. 13 shows a dance pad, according to an embodiment.

FIG. 14 is a top view of a portion of a guitar video game controller having a decoration that is operable to be lighted or illuminated with a light, according to one or more embodiments.

FIG. 15 shows a perspective view of a guitar and/or guitar game controller decorating apparatus, according to one embodiment of the invention.

FIG. 16 shows a cross-sectional view of a plurality of ink-jet spray nozzles or printheads spraying or otherwise applying a radiation-sensitive ink composition over a surface to be coupled with a guitar game controller which is positioned on a bed or carrier, according to one embodiment of the invention.

### DETAILED DESCRIPTION

In the following detailed description, reference is made to the accompanying drawings which form a part hereof, and in which is shown, by way of illustration, specific embodiments in which the invention may be practiced. These embodiments are described in sufficient detail to enable those skilled in the art to practice the invention. Other embodiments may be utilized and structural, logical, electrical changes, etc. may be made without departing from the scope of the present invention.

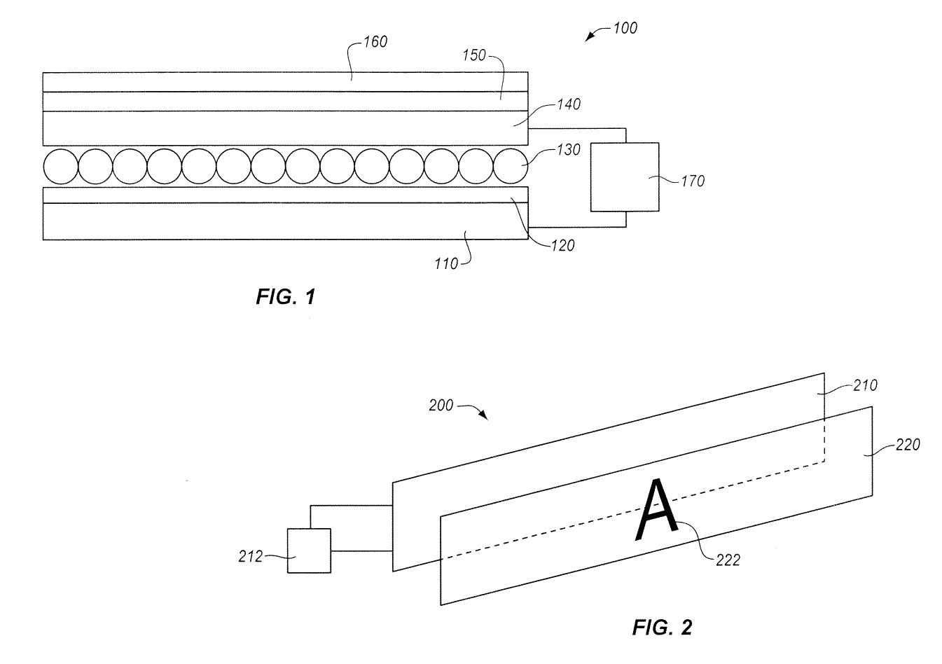

FIG. 1 shows a gaming controller 100 utilizing electroluminescent (EL) technology. A conducting base 110 is shown with a dielectric layer 120 coupled to the conducting base 110. The base is for some embodiments rigid and for other embodiments flexible. This feature enables the gaming controller to be positioned on rigid or flexible surfaces. A number of encapsulated phosphor portions 130 are shown coupled to the dielectric layer 120. In some embodiments, a number of encapsulated phosphor portions 130 are microencapsulated. A second conducting portion 140 is shown coupled over the number of encapsulated phosphor portions 130. In some embodiments, the second conducting portion 140 includes a transparent conductor material. In some embodiments, an encapsulating layer 150 is included over the second conducting portion 140. In some embodiments, the encapsulating layer 150 is included to provide moisture or weather resistance. A pattern layer 160 is further shown coupled over the encapsulating layer 150. In some embodiments, the pattern layer 160 defines a message or symbol. As will be explained further below, in one or more embodiments, the pattern may include a decoration through which light from the electroluminescent (EL) technology is transmitted.

One of ordinary skill in the art, having the benefit of the present specification will recognize that alternative designs of an EL lighting device are possible. FIG. 1 is intended to illustrate one possible embodiment of an EL lighting configuration in a gaming controller. One good example of EL lighting can be obtained from the Durel Corporation of Chandler, A Z.

FIG. 2 shows an embodiment of a gaming controller 200. The gaming controller 200 includes an EL lighting surface 210, and a power source 212 coupled to the EL lighting surface 210. In some embodiments, the power source 212 includes an AC power source. In some embodiments, the power source 212 includes a DC power source coupled to an AC converter. In some embodiments, the power source is supplied by a power hook up. A layer 220 is also included, with a pattern 222 located on the layer 220. In FIG. 2, the layer 220 includes a transparent layer. The pattern 222 in FIG. 2 is substantially opaque. Embodiments of patterns 222 include, but are not limited to, text, numbers, symbols, shapes, decorations, etc. The gaming controller 200 operates by transmitting light from the EL lighting surface 210 through portions of the layer 220 that are not obscured by the pattern 222. The pattern may also be a decoration which is partially translucent.

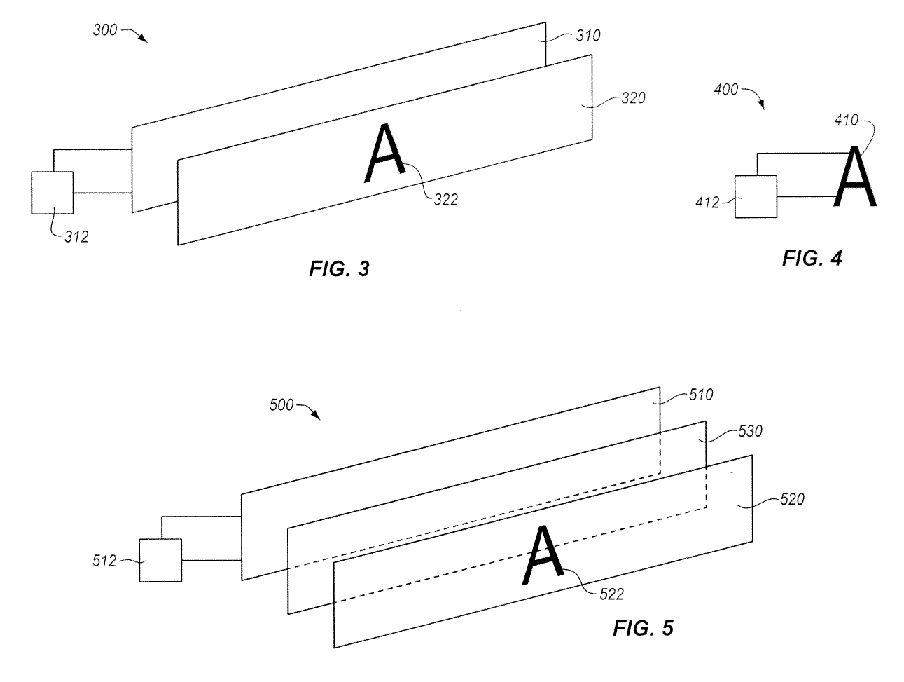

FIG. 3 shows an embodiment of a gaming controller 300. The gaming controller 300 includes an EL lighting surface 310, and a power source 312 coupled to the EL lighting surface 310. Power source 312 includes, but is not limited to embodiments of power sources described above. A layer 320 is also included, with a pattern 322 located on the layer 320. In FIG. 3, the layer 320 includes a substantially opaque layer. The pattern 322 in FIG. 3 is substantially transparent. In some embodiments, the pattern 322 is cut out from the layer 320. Pattern 322 includes, but is not limited to embodiments of patterns described above. The gaming controller 300 operates by transmitting light from the EL lighting surface 310 through the substantially transparent pattern 322.

FIG. 4 shows an embodiment of a gaming controller 400. The gaming controller 400 includes an EL lighting surface 410, and a power source 412 coupled to the EL lighting surface 410. Power source 412 includes, but is not limited to embodiments of power sources described above. In some embodiments, the EL lighting surface 410 is shaped into a pattern. The pattern includes, but is not limited to embodiments of patterns described above. The gaming controller 400 operates by transmitting light from the EL lighting surface 410 directly in a pattern that conveys a message.

FIG. 5 shows an embodiment of a gaming controller 500. The gaming controller 500 includes an EL lighting surface 510, and a power source 512 coupled to the EL lighting surface 510. Power source 512 includes, but is not limited to embodiments of power sources described above. A layer 520 is also included, with a pattern 522 located on the layer 520. In FIG. 5, the layer 520 includes a transparent layer. The pattern 522 in FIG. 5 is substantially opaque. Alternatively, the layer 520 in FIG. 5 may include a substantially opaque layer with a pattern 522 that is substantially transparent. A layer 530 is further included in the gaming controller 500. The layer 530 includes properties that alter a color of the EL lighting surface 510.

Selected embodiments of gaming controllers as described in this document include colored EL material. Both an illuminated color and a non-illuminated color may be selected. Possible colors include yellow, white, blue-green, etc. A color can be chosen in the non-illuminated condition that is suited for daytime, while a different color can be chosen for the illuminated condition to optimize both day and night. The addition in gaming controller 500 of a layer 530 further broadens color options. In some embodiments, the layer 530 is tinted to alter the color of the EL lighting surface. In some embodiments, an EL lighting surface is included that is white in a non-illuminated condition, and blue-green in an illuminated condition. In some embodiments, a yellow tinted layer 530 is further included. This provides a yellow appearance in the day, with a light green appearance at night. In some embodiments, the light green complies with government regulations for color. In another embodiment, an EL lighting surface is included that is yellow in a non-illuminated condition, and yellow in an illuminated condition. In some embodiments, a yellow tinted layer 530 is further included. This provides a yellow appearance in the day, and a yellow appearance at night. These are just example embodiments, and are not required.

In some embodiments, the pattern 522 is cut out from the layer 520. Pattern 522 includes, but is not limited to embodiments of patterns described above. The gaming controller 500 operates by transmitting light from the EL lighting surface 510 through the layer 530 and through substantially transparent portions of the layer 520. A decoration that is at least partly translucent may be applied to the layer 530 or the layer 520 so that light is transmitted through the decoration.

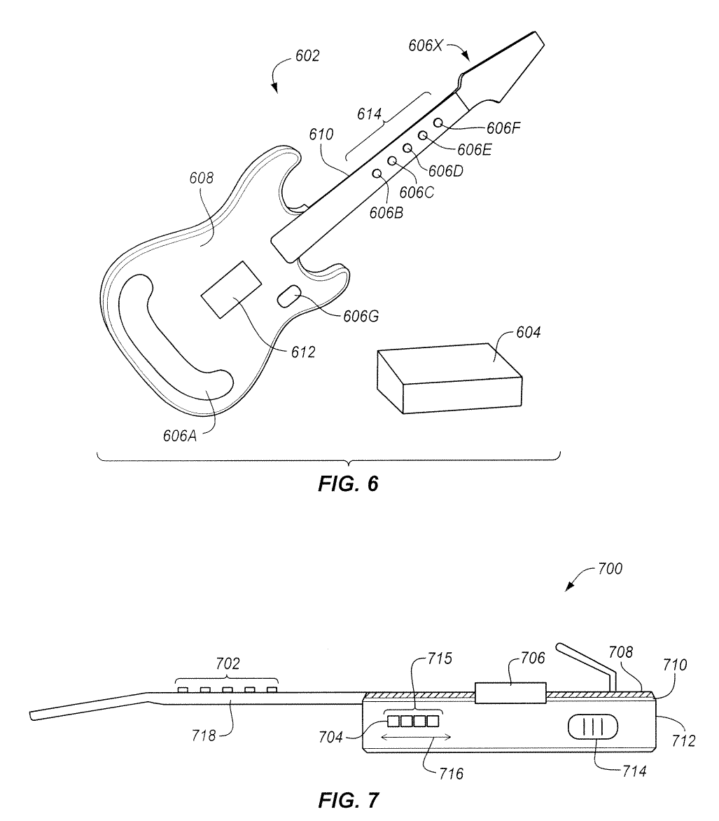

FIG. 6 shows a gaming controller 602 and a console 604, according to an embodiment. The gaming controller includes an EL lighting surfaces 606A-X. In some embodiments the gaming controller is guitar shaped, but the present subject matter is not so limited. Some guitar shaped embodiments include a face plate or body 608. The face plate 608 can include a single piece of EL or multiple pieces of EL. In some embodiments, the face plate is covered with EL. In some additional examples, one or more pieces of EL are sandwiched between a mask and a backing plate. The backing plate is releasably coupled to the guitar 610 in some examples. In other examples, EL is attached directly to guitar 610. EL can be laminated to guitar 610 in some examples. In some examples, EL is adhered to guitar 610. In some embodiments, EL is protected by a protective layer. Embodiments are included in which a polyester layer is laminated to an EL lamp. Embodiments are additionally included in which a vinyl layer is laminated to an EL lamp. In some examples, a laminate is hot rolled to an EL lamp. Some embodiments hot roll EL at 225 degrees Fahrenheit. Some embodiments heat a portion of a laminate for around 2 seconds. In some examples, a laminate extends beyond an EL lamp to envelop the EL lamp.

EL is additionally attached to a guitar head in some embodiments. Some embodiments attach EL to one or more fret buttons 606B-F. In some embodiments, EL is disposed inside a translucent or transparent button. In additional embodiments, EL is disposed one or more fret buttons 606B-F.

One or more of the EL lamps illustrated in FIG. 6 is controlled via a switch in some examples. For example, in some embodiments, the EL lamps are always on in a first mode, or flash in a second mode. Some examples use a signal from the console 604 to control one or more of the EL lamps. Some examples control one or more EL lamps according to the operation of one or more inputs of the gaming controller 602. For example, a strum button 612 can be used to activate or deactivate one or more EL lamps coupled to the guitar.

One or more of the fret buttons 614 can be used to activate EL lamps in some examples. Other buttons can also illuminate EL lamps. In some embodiments, depressing button 606B illuminates a first EL lamp, and depressing button 606C illuminates a second EL lamp other than the first. Depressing a combination of fret buttons can illuminate both the first and second EL lamps. Some examples, the combination illuminates a third EL lamp in some embodiments.

In some examples, the console 604 controls one or more EL lamps. For example, in some embodiments, a software program such as a game measures user performance and ranks it according to a predetermined algorithm. In some examples, the algorithm monitors the number of times a player presses a button correctly according to the recommendations of a prompt. Such a prompt can indicate which button to push at which time in some examples, but the present subject matter is not so limited. In some examples, the success rate of the user in addressing the needs of the prompt is associated with a cumulative counter. A cumulative counter can include a health meter in some examples, but the present subject matter is not so limited. In some embodiments, the EL of the guitar 602 is controlled to illuminate or remain unilluminated according to the success of a user in addressing a prompt. For example, in some embodiments, one or more EL buttons blink and an increasingly faster rate as a health meter level becomes increasingly positive. Other examples operate conversely. In some examples, EL is controlled to illuminate at an increasing brightness as performance increases. Some software programs monitor a user's performance for catastrophic failure (e.g., death of a character). In some examples, catastrophic failure prompts flashing of one or more EL lamps of the guitar 602.

Various methods are contemplated. Some methods include communicating a signal associated with user performance from a gaming console to a gaming controller. Some methods include controlling an EL lamp coupled to the gaming controller according to the signal. Some methods include continuously illuminating the EL lamp. Some methods include blinking the EL lamp. Some methods include blinking the EL lamp according to a control signal, such as from a console 604. Some methods include obtaining EL lighting that includes illuminated and non-illuminated regions having different colors. Some methods include attaching a layer to the illuminated regions wherein the layer changes the color of the regions.

Flashing of the EL lamps of the guitar 602 often is for the benefit of persons watching a user operate the guitar 602, as the user is focused on an interface, such as a television, to report their progress. By allowing the console 604 to control EL lamps, the onlooker's experience is improved by adding flashing lights that can entertain a user. For example, some software applications include an interface such as a television that shows a character changing as successful prompts are met. In some examples, a character or a tool used by a character is ignited, for example. In such instances, one or more EL lamps of the guitar 602 can be illuminated in concert with the characters changes. In some examples, the head of the guitar 606X flashes to provide an indicator of a condition to a user or to an onlooker.

FIG. 7 shows a top view of a guitar 712, according to an embodiment. Fret buttons 702 are coupled to a neck 718 in some embodiments. The fret buttons 702 are illuminated by one or more EL lamps in some embodiments. In some examples, each of the fret buttons 702 is illuminated by an individually controllable EL lamp. In some examples, depressing a button illuminates an EL lamp associated with the button. EL lamps can be associated with a button by being adhere to them or by backlighting them. Some examples use LED lights for buttons in stead of or in addition to EL lamps.

In some examples, the neck is removable, but the present subject matter is not so limited. The neck is part of the guitar 712. An EL Lamp 710 is sandwiched between a protective covering 708 and a guitar 712 in various examples. The protective covering can include translucent plastic. A connector 714 is illustrated. The connector in some examples is in communication with the fret buttons 702 and the strum button 706 such that depression of any of those buttons provides a signal to the connector 714. In some examples, the connector 714 is in connection with one or more EL lamps coupled to the guitar 712. The connector 714 provides a back-up wired communication tool in examples in which the gaming controller 700 is wireless.

In some examples, if a user is busy focusing on a first portion of an interface and is unable to see a second portion of an interface, a secondary indicator in addition to a visual indicator could be used. Such a secondary indicator could include a sound or a vibration from the gaming controller 700. Such a secondary indicator can also include EL lamp illumination.

As mentioned above, in some examples it is difficult for a user to see one or more of the EL lamps of a gaming controller. For example, a user focused on an interface such as a television might not be able to see EL lamps coupled to guitar 712. For example, light from EL lamp 710 might be difficult to see. Light from the fret buttons 702 likewise might be difficult to see. As such, associating these lights with helpful user feedback has limited effectiveness.

To at least partially address this problem, the top of the guitar 712 includes an EL lamp 704 that is useful to communicate information. For example, the EL lamp 704 can illuminate blocks 715 in sequence 716 traveling from the body to the head to indicate increasing user performance (e.g., health) in some examples.

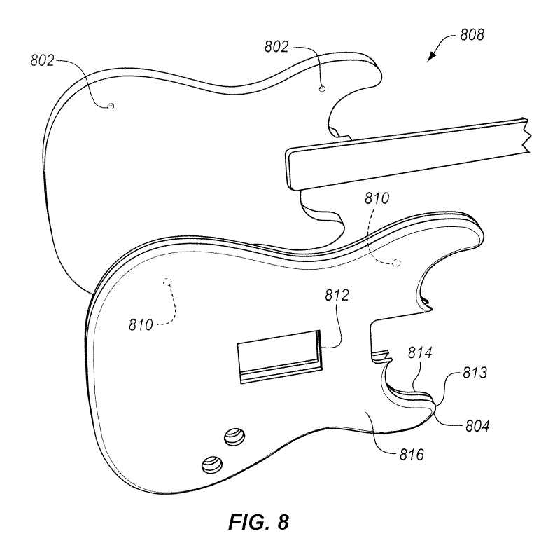

FIG. 8 shows a guitar and an EL faceplate, according to an embodiment. The illustration is suitable for retrofit to a gaming controller 808. For example, the ball connectors 802 mates to the ball connector socket 810 in some embodiments. The plate 804 as such is releasably couplable to the gaming controller 808. An aperture 812 is provided in the plate 804 so that a strum button can be disposed through the plate 804.

In various embodiments, an EL lamp 813 is sandwiched between a face plate 816 and a back plate 814, such as via a lamination process. In various embodiments, the face plate 816 includes a mask such that EL light passes through only a portion of the face plate 816. In some embodiments, the EL lamp includes electrically isolated portions that shine through respective windows in the face plate 816. EL lamps can be individually wired such as by routing a flat cable between the EL lamp and the back plate 814. The assembly can be laminated together to provide a uniform profile. In embodiments where the EL lamps and associated connections are provided, an adhesive is provided to fill in interstices such that the back plat 814 is securely coupled to the EL lamp 813 and the face plate 816.

In some examples, the face plate 816 includes a frame, and an EL lamp is disposed in the frame. In some of these examples, Plexiglas is disposed in front of the EL lamp to protect it.

Various embodiments include a controller for the EL lamp. The controller can include a battery pack. In some examples, the battery pack includes an inverter. In additional examples, the battery pack and the inverter are packaged separately. The controller in some examples is adapted to control multiple EL lamps. In some examples, an input from the guitar 808, such as a button, is electrically coupled to the controller such that the controller receives a signal and illuminates one or more EL lamps in response to the signal.

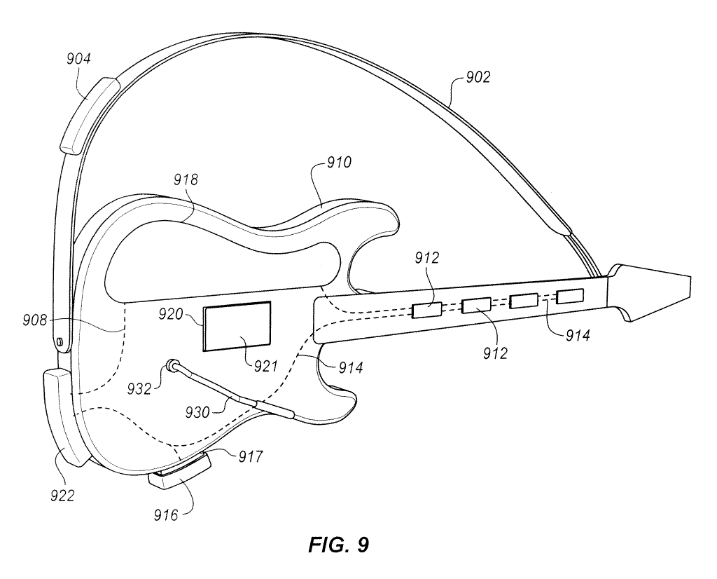

FIG. 9 shows a guitar 910, EL lamps and a power pack, according to several embodiments. In various embodiments, a strap 902 is provided to support the guitar 910. At least one EL lamp 918 is coupled to the guitar 910. As disclosed herein, the EL lamp can be laminated to the guitar. The EL lamp can be adhered to the guitar. In some examples, one or more EL lamps are adhered to a guitar, and a protective film is laminated to the EL lamp. The protective film can be essentially clear in some embodiments. In additional embodiments, the protective film can be at least partially tinted. In some examples, the protective film is at least partially masked. In some examples, the mask includes apertures. In additional embodiments, the mask includes indicia. Some indicia include graphics, but the present subject matter is not so limited. Some examples include a whammy bar aperture 932 through which a whammy bar (also known as a pitch bending bar) 930 extends. Some examples include a strum button aperture 920 through which a strum button 921 extends. Some examples include one or more EL lamps 912 along the neck of the guitar 910. The EL lamp on the neck 912 can be attached to the neck with any of the attachment mechanisms used to attach the EL lamp 918 to the body of the guitar 910. One or both of the EL lamps 912, 918 can be releasably coupled to the guitar 910 as disclosed herein.

The illustrated embodiment shows a guitar with EL and with external battery packs. In a first option a battery pack 922 is coupled to the guitar 910. Attachment can be via a snap fit to a mating feature on the guitar, via double sticky tape or other means. The battery pack is coupled to one or more EL lamps 912, 918 via a wiring harness 908 in various embodiments. In various embodiments, the wiring harness 908 is taped to the guitar 910. In various embodiments, the battery pack 922 includes battery and an inverter to cover DC power to AC power suitable to illuminate an EL lamp.

In an optional alternate embodiment, a battery pack 904 is attached to a strap 902, and is connected to one or more lamps via a wiring harness. In yet another optional alternate embodiment, a battery pack 916 is attached to a connector 917 of the guitar 910. In various embodiments, a connector 917 is integrated into the guitar such as being molded into plastic of the guitar. In various embodiments, the connector 917 is in communication with electronics of the guitar 910. In some examples, the connector 917 serves as a connection point when a user seeks to operate the guitar 910 via wired control instead of wireless control. In various embodiments, contacts that are part of the connector 917 are in communication with buttons of the guitar 910, such as the whammy bar 930 and the strum button 921. In various embodiments, a wiring harness 914 couples the battery pack 916 to EL lamps coupled to the guitar. In some examples, battery power is provided by a power source internal to the guitar 910, and an inverter is coupled to connector 917. A game controller may also optionally receive power from a console or other external source.

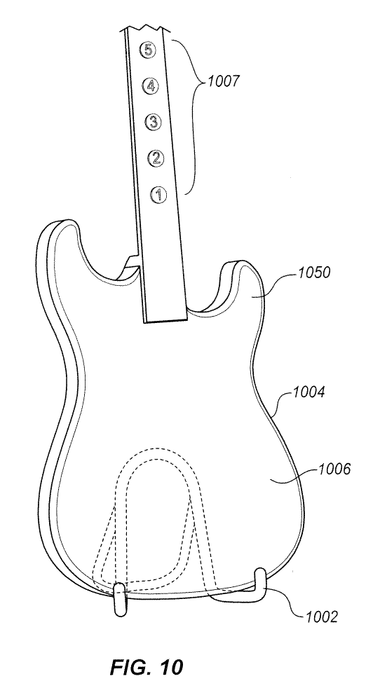

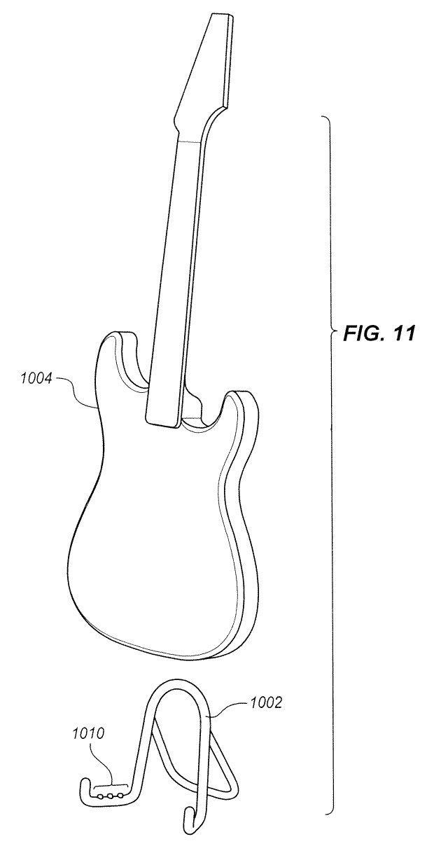

FIG. 10 shows a guitar shaped gaming controller in a cradle, according to an embodiment. Various embodiments include a guitar 1004. In various embodiments EL is coupled to the body 1006 of the guitar 1004. In various embodiments, the gaming controller includes one or more fret buttons 1007. In various embodiments, one or more of the fret buttons includes an EL lamp. An EL lamp can backlight a translucent fret button in various embodiments. In some embodiments, one or more fret buttons demonstrate different colors. In some examples, colors are provided via filters applied to an EL lamp. In additional embodiments, colors are provided via filters applied to a fret button. In some embodiments, one or more fret buttons are molded with a tint. Some embodiments are laminated with a tint. Other configurations are possible. In some examples, illuminated color of the EL lamp is different from the non-illuminated color. In some examples, EL lamp colors comprise two or more of yellow, white, and blue-green. In some examples, an EL lamp further comprises a layer that imparts a yellow tint to the sign. In some examples, an EL lamp further comprises a layer that alters the color of the EL lighting.

In various embodiments, batteries of the guitar 1004 charge while the guitar is in a cradle 1002. In some embodiments, the guitar 1004 monitors battery level and switches charging between a charging mode and a non-charging mode. Some examples indicate to a user that charging is occurring. In some examples, charging is indicated via one or more lamps that stay constantly illuminated. In some examples, charging is indicated via a lamp changing from a first color to a second color during charging. For example, in some embodiments, a lamp 1050 that is lit green during use of the guitar 1004 is illuminated red during charging of the guitar. In some examples, a power meter is optionally provided. Such a power meter can include a plurality of bars that incrementally illuminate. In some examples, the buttons 1007 sequentially illuminate during charging. For example, in some embodiments, buttons 1-5 illuminate according to the following repeating sequence steps:

1 constantly illuminated,

1 and 2 constantly illuminated,

1, 2 and 3 constantly illuminated,

1, 2, 3 and 4 constantly illuminated,

1, 2, 3, 4 and 5 constantly illuminated.

In various examples, button 5 is located toward the head of the guitar, while button 1 is located toward the body of the guitar.

FIG. 11 shows a guitar and a cradle, according to an embodiment. The guitar 1004 is placed into electrical communication with the cradle 1002 via a guitar electrical contact coming into contact with a cradle electrical contact 1010, according to some embodiments.

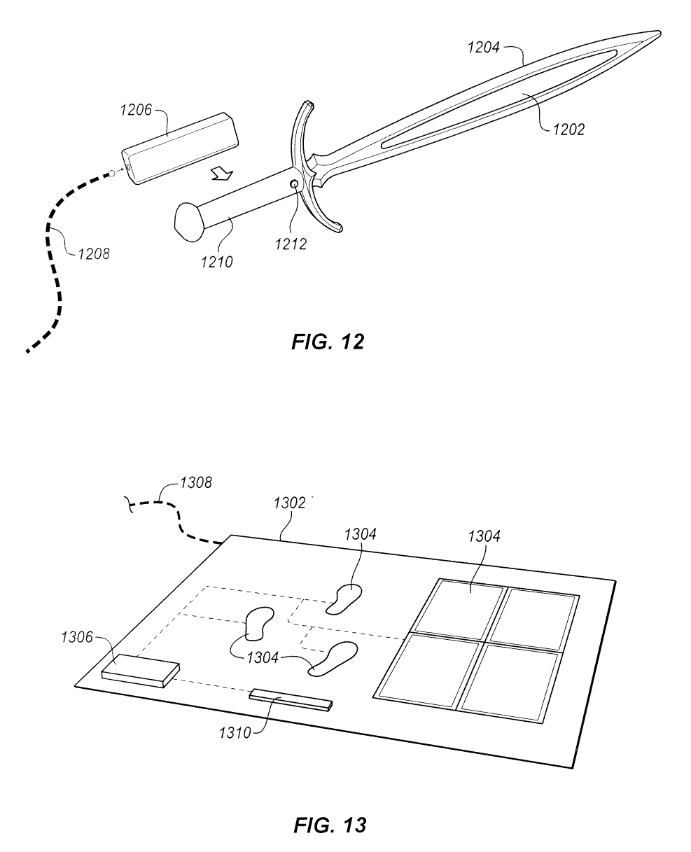

FIG. 12 shows a sword with EL, according to an embodiment. In various embodiments, a gaming controller 1204 includes a handle portion 1210 sized to receive a wireless controller 1206. The controller is put into electrical communication with EL 1202 coupled to the gaming controller 1204 to illuminate the EL lamp. In some examples, depressing button 1212 illuminates EL lamp 1202. In additional embodiments, a console communicates a signal to the controller 1206 instructing the controller to control the EL lamp 1202 to illuminate. Optional embodiments are not wireless and communicate between a console and a controller 1206 via optional cable 1208.

FIG. 13 shows a dance pad, according to an embodiment. In various embodiments, the dance pad 1302 includes one or more buttons 1304. In various embodiments, a power supply 1306 supplies EL lamps coupled to the buttons 1304. In some examples, EL backlights the buttons 1304. In additional embodiments, EL is laminated to the buttons 1304. In various embodiments, the power supply 1306 includes an inverter. In some embodiments, the dance pad 1302 is wireless. In additional embodiments, the dance pad is wired via optional cable 1308. Communications are provided in some embodiments via a dance pad control circuit 1310. In some examples, the power supply 1306 is controlled by the dance pad control circuit 1310.

An apparatus according to embodiments includes, a gaming controller powered by a first power source, and an EL lamp coupled to the gaming controller and powered by a second power source, the EL lamp removably coupled to the gaming controller to mask a portion of the gaming controller. In some embodiments, the EL lamp is laminated to the gaming controller. In some embodiments, the EL lamp is adhered to the gaming controller. In some embodiments, the EL lamp is adhered to a plate that is mechanically coupled to the gaming controller. In some embodiments, the gaming controller comprises a guitar. Some embodiments further include at least one LED lamp coupled to the gaming controller and powered by the second power source.

A system according to embodiments includes a gaming controller. The gaming controller includes a gaming control circuit to receive inputs and communicate a control signal based on the inputs, a wireless transceiver to wirelessly communicate the control signal, and a controller connector coupled to the controller to communicate the control signal via wired communications. The system also includes an EL system coupled to the gaming controller. The EL system includes at least one EL lamp coupled to the gaming controller, an inverter coupled to the EL lamp to light the EL lamp according to the control signal, an EL control circuit to control power to the inverter based on the control signal, an EL lamp connector coupled to the EL control circuit, and a connector communicatively coupling the EL lamp connector and the gaming connector such that the gaming control circuit is communicatively coupled to the EL control circuit. In some embodiments, the inverter includes a monitor circuit to monitor capacitance of the EL lamp and to provide an EL lamp capacitance signal, and a compensation circuit to adjust voltage to the EL lamp based on the EL lamp capacitance signal. In some embodiments, the system further includes a power source to power the gaming controller and the EL system, the power source being coupled to the gaming controller. In some embodiments, the system further includes a first power source coupled to the gaming controller to power the gaming controller and a second power source coupled to the EL system to power the EL system. In some embodiments, the system further includes a cradle to connect to the second power source.

A method according to embodiments includes communicating a signal associated with user performance from a gaming console to a gaming controller, and controlling an EL lamp coupled to the gaming controller according to the signal. In some embodiments the method further includes continuously illuminating the EL lamp. In some embodiments the method further includes blinking the EL lamp, in some embodiments according to the signal. In some embodiments the method further includes obtaining EL lighting that includes illuminated and non-illuminated regions having different colors. In some embodiments the method further includes attaching a layer to the illuminated regions wherein the layer changes the color of the regions.

In various embodiments, the brightness of the controller is maintained over time, using, among others, the apparatus and method disclosed in U.S. Pat. No. 5,089,748, an expired patent, the entire specification of which is incorporated herein by reference in its entirety. This patent discusses automatic feedback controls that adjust brightness based on any number of monitored properties of the EL, including, but not limited to resistance and/or capacitance. Some embodiments monitor ambient temperature and adjust voltage and/or other energy supplies to one or more EL lamps so that the perceived brightness is constant over temperature swings and/or exposure of one or more EL lamps to direct sunlight. Other methods of control, include, but are not limited to, safety methods, reset methods and animation methods.

Embodiments are configured to animate one or more EL lamps using animation apparatus and method associated with FIGS. 3 and 16-17, and the portions of the specification which discuss those figures, described in U.S. patent application Ser. No. 12/195,006, which is commonly assigned, and which was filed Aug. 20, 2008.

In one or more embodiments, a guitar or a guitar video game controller may include a decoration and a light to illuminate the decoration and/or transmit light through the decoration. A few representative examples of suitable decorations include, but are not limited to, photographs, digital images, color photographs or digital images, graphics, computer generated graphics, artwork, logos, words, other decorative patterns, or the like, and combinations thereof. In one or more embodiments, the decoration may represent a photographic quality representation of a digital image or a dot matrix representation of a digital image. In one or more embodiments, the decoration may be an ultraviolet (UV) printed decoration formed by a UV printer. For example, the decoration may include a multi-colored dot matrix representation that includes dots having crosslinked inks. Alternatively, in one or more embodiments, the decoration may be formed by other approaches besides UV printing. For example, the decoration may be formed by other printing processes, such as, for example, silkscreen printing, digital ink jet printing with solvent inks, to name just a few examples. The decoration may be at least partially translucent. A few representative examples of suitable lights include, but are not limited to, electroluminescent lamps, electroluminescent lights, light emitting capacitors (LECs), electroluminescent phosphors, light emitting diodes, and other known semiconductor light sources. The light may help to illuminate the decoration and/or transmit light through the decoration, which may allow the decoration to be better seen or viewed particularly in darker or lower light environments. Optionally, the lighting of the decoration may be used to provide feedback to a user of the guitar or guitar shaped video game controller or a viewer(s) or onlooker(s), or otherwise communicate information associated with the playing of the guitar or controller to the user or the viewer(s) or onlooker(s).

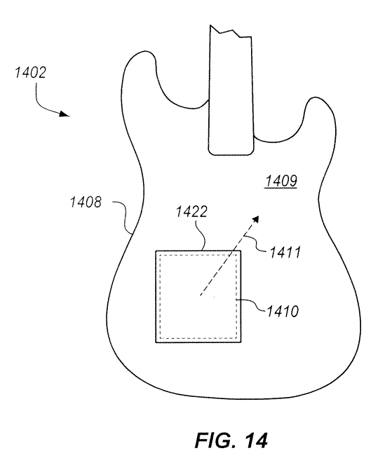

FIG. 14 is a top view of a portion of a guitar video game controller 1402 having a decoration 1422 that is operable to be lighted or illuminated with a light 1410, according to one or more embodiments. The decoration 1422 is applied to a front 1409 of a body 1408 of the guitar video game controller. The decoration may represent any of the aforementioned decorations. The light 1410 is positioned behind the decoration to transmit visible light 1411 through the decoration. By way of example, the light may be or include one or more electroluminescent lights or one or more LEDs. Other embodiments are not limited to the illustrated position or size of the decoration. In one or more embodiments, the decoration or decorations may cover at least a majority or substantially all (meaning herein at least 80% by area) of the front of the body. Optionally, one or more decorations may be included on other portions of the guitar video game controller, such as the neck or the back of the body.

In one or more embodiments, the decoration may be printed directly on or over a surface of the light. For example, the decoration may be digitally ink jet printed directly on a surface of an electroluminescent light. If desired, a white or substantially white layer, or another mask layer, or layer to change the color of the light, may optionally be printed, painted, rolled, or otherwise applied to the light before the decoration is applied. The electroluminescent lamp may then be adhered with an adhesive or otherwise applied or coupled with the body of the guitar or guitar video game controller either before or after the decoration has been applied.

As another option, in one or more embodiments, the decoration may be printed or applied on a surface of a thin transparent, at least partially transparent, translucent, or at least partially translucent sheet, layer, or material, which is to be sandwiched or coupled between the decoration and the light. In various examples, the sheet, layer, or material may be the layer 220 in FIG. 2, or one of the layers 530 or 520 in FIG. 5. In one particular example, the decoration may be printed on a thin sheet of transparent or translucent vinyl or other polymeric material. In various embodiments, the thin sheet may be clear, white, or substantially white (e.g., ivory or other off-white colors), or sufficiently light colored so as not to interfere with the decoration (e.g., pale yellow or pale grey, etc.). The thin sheet or other thin transparent or translucent material may then be adhered or otherwise coupled on or over the electroluminescent or other light. The electroluminescent light may be adhered to the guitar or guitar video game controller or a portion thereof either before or after the decoration residing on the thin sheet or layer is adhered to the light. This approach may offer the advantage that the thin sheet may be less expensive than the electroluminescent lamp or light and in cases may help to avoid ruining an electroluminescent lamp or light if the decoration is ruined or applied badly or incorrectly.

In one or more embodiments, the electroluminescent lamp or the thin transparent or translucent sheet or layer on which the decoration is printed or applied may be sized to cover at least a majority, or in some cases substantially all, of a front surface of a body of the guitar or guitar game controller. In one or more embodiments, the surface may be shaped substantially like at least a majority or in some cases substantially all of the front surface of the body. Alternatively, they may be cut to have these sizes or shapes.

In one embodiment of the invention, the decoration may be formed or applied over one of the aforementioned surfaces, such as a surface of a light or a thin transparent or translucent sheet to be sandwiched or coupled between the decoration and the light, by printing, spraying, or otherwise applying a radiation-sensitive material over the surface and then polymerizing, cross-linking, solidifying, or otherwise curing the radiation-sensitive material over the surface by exposing the material to appropriate actinic radiation. The decoration may include a solid, cross-linked, polymerized, radiation-cured material having inks dispersed therein. In one embodiment of the invention, the decoration may be formed over the surface by ultraviolet (UV) printing. In this embodiment of the invention, the decoration may include a cross-linked material cured by actinic UV radiation and having the inks dispersed therein.

UV printing may offer a number of potential advantages. The decorations applied by UV printing tend to be durable, high quality, and the rapid printing speeds tend to lend the process to mass production. The UV printing process also tends to work well on wood, plastics, and on polymers of the type often used in the manufacture of guitars and/or guitar game controllers.

Now, consider an exemplary method of forming the decoration over the surface. A method of decorating at least a portion of a guitar or guitar game controller, according to one embodiment of the invention, may include providing a surface to be printed on, such as, for example, a surface of an electroluminescent light, or a thin sheet of transparent or translucent material, and applying a decoration over the surface by spraying a radiation-sensitive ink composition or light-activated ink over the surface with one or more ink-jet spray nozzles or printheads and exposing the radiation-sensitive ink composition to radiation or light.

If desirable, the surface may optionally be sanded or otherwise roughened prior to printing, although this is not required. The roughening of the surface may tend to improve adhesion of the decoration. In one embodiment of the invention, the surface may be roughened with 280 to 400 grain sand paper, or the equivalent, to provide good adhesion.

According to yet another embodiment of the invention, the decoration may optionally be formed directly on a UV print primer coating or mask. A suitable UV print primer coating is the 51209B print primer available from Northwest Coatings, of Oak Creek, Wis. The 51209B print primer includes a mixture of acrylate monomers and oligomers having a boiling point of greater than 200° C. and a vapor pressure of less than 1 mm Hg at 25° C. Other UV print primers may also optionally be employed. A coating of the UV print primer may be formed over the surface. In one aspect, the primer may be sprayed over the surface. Painting, roll-coating, dip coating, and other methods of application may also optionally be employed. Printing the decoration directly on the UV print primer coating may tend to enhance the printing and adhesion of the decoration.

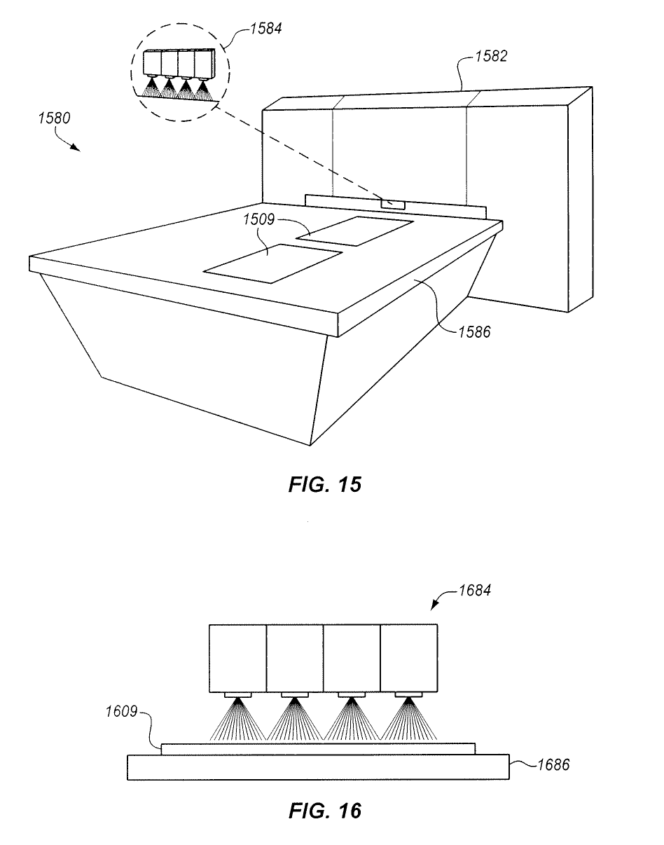

FIG. 15 shows a perspective view of a guitar and/or guitar game controller decorating apparatus 1580, according to one embodiment of the invention. The apparatus includes a jet-printing device 1582, a plurality of ink-jet spray nozzles or other printheads 1584 of the jet printing device, and a bed 1586 to receive surfaces 1509 to be printed on. The apparatus also includes an integrated digital graphics computer interface (not shown), the integrated digital graphics computer interface to cause the plurality of ink-jet spray nozzles 1584 to spray radiation-sensitive ink in the form of a decoration onto the surface to be printed on. The apparatus also includes a radiation source or light (not shown), such as a UV light, to apply light to the decoration on the surface to cause crosslinking.

In one embodiment of the invention, the apparatus may include a high-speed jet-printing apparatus such as a UV ink-jet printer. A variety of UV ink-jet printers are commercially available from numerous sources. Suitable UV ink-jet printers include, but are not limited to, the Durst Rho 160, available from Durst Dice America, of Rochester, N.Y., the 3M® Printer 2500 UV brand printer, available from 3M Commercial Graphics Division, of St. Paul, Minn., the Inca Eagle 44, available from Sericol Imaging, of Kansas City, Kans., the Leggett and Platt Virtu, available from Leggett & Platt Digital Technologies, of Jacksonville Beach, Fla., the Scitex VeeJet, available from Scitex Vision America Inc., of Marietta, Ga., the PRESSVU UV™ 180/600 EC and PRESSVU UV™ 180/360 EC brand printers, both available from VUTEk, Inc., of Meredith, N.H., and the Zund Uvjet 215, available from ACCI, of Edina, Minn. Another notable printer is the UJF-605C Flatbed UV Inkjet Printer, available from Mimaki Engineering Co., LTD, of Tokyo, Japan.

Prior to printing, a digital image may be loaded into the apparatus. The apparatus may include an integrated digital graphics computer interface. In one aspect, in addition to accessing the digital image, a shape file may be accessed. The shape file may have a shape associated with a shape of a guitar game controller onto which the decoration is to be applied. Different files may be provided for different types or shapes of guitars, such as Stratocaster, V-shape, or the like. The integrated digital graphics computer interface may rasterize the digital image for the printer. A printer driver may be used for this purpose. Then, the rasterized representation of the digital image may be used by the integrated digital graphics computer interface, or another suitable controller, to control the printing or other application of the decoration on the surface by the ink-jet spray nozzles.

FIG. 16 shows a cross-sectional view of a plurality of ink-jet spray nozzles or printheads 1684 spraying or otherwise applying a radiation-sensitive ink composition over a surface 1609 to be coupled with a guitar game controller which is positioned on a bed or carrier 1686, according to one embodiment of the invention. As used herein, the term radiation-sensitive ink composition refers to a composition including ink that is sensitive to radiation and capable of being chemically transformed by the radiation. As used herein, the term ink refers broadly to a colorant and may include inks, dyes, pigment, other colorants (e.g., carbon black), or a combination. In one embodiment of the invention, the radiation-sensitive ink composition may include a UV radiation curable ink composition that is capable of being polymerized, potentially cross-linked, and at least partially solidified by UV radiation. The UV radiation may initiate a polymerization reaction, which may cause polymerization, for example cross-linking, of components in the composition in order to create the solid coating. A heat-activated ink composition may also optionally be employed.

The UV radiation curable ink composition may include one or more monomers, oligomers, inks, and photoinitiators. The monomers often form the bulk of the composition and may be used to adjust the viscosity. In some cases a mixture of monomers, such as monomers capable of giving polyesters and polyacrylates, may be employed. The oligomers often provide properties such as resistance and flexibility to the cured coating. The photoinitiator generally represents a molecule or other species that is sensitive to UV radiation and that is capable of initiating a polymerization reaction when exposed to the UV radiation. The compositions generally contain low levels of solvents or are solvent free.

Suitable UV radiation curable ink compositions are commercially available from numerous sources. One suitable composition includes the UV curable ink-jet ink called Uvijet, which is commercially available from Sericol Imaging, of Kansas City, Kans. Other suitable compositions are known in the arts.

In the illustrated embodiment, four nozzles or printheads 1684 are shown. In one aspect, the four nozzles may include separate nozzles for cyan, magenta, yellow, and black colored UV ink compositions. These inks are occasionally known in the arts as CMYK inks. In another embodiment of the invention, the plurality of nozzles may include an additional nozzle for white or substantially white inks. As will be explained further below, the white may, among other things, be useful for forming a mask layer over which an image may be applied to help mask underlying colors or features of the surface of the guitar or guitar game controller and/or improve image quality. In yet another alternate embodiment, the plurality may include additional nozzles for light magenta and light cyan. The provision of these additional colored UV ink compositions may help to improve image quality. Accordingly, in one example, the plurality may include seven nozzles, for cyan, magenta, yellow, black, white, light magenta, and light cyan. Other color combinations besides those based on CMYK may also optionally be employed.

In spraying the composition on the surface, the distance from the ink-jet spray nozzles or printheads to the surface may affect the visual quality of the decoration. The UJF-605C Flatbed UV Inkjet Printer from Mimaki tends to print well when the distance from the ink-jet spray nozzles to the surface being printed on is in the range of from about 1 to 2 inches. Using such a distance is not required, but may help to promote good print quality. Other distances may be appropriate for other printers.

Shortly after the composition is sprayed on the surface, the radiation-sensitive or UV radiation curable ink composition may be exposed to actinic radiation, for example UV radiation or light, to polymerize, cross-link, solidify, and cure the composition on the surface as a durable decoration. The apparatus may include a bulb, lamp, or other radiation source to provide the UV or other radiation. In the UV ink-jet printing arts, the radiation often includes UV radiation having a wavelength in the range of 200 to 400 nanometers (nm). The radiation may promote the polymerization, cross-linking, solidification, and curing process. In one aspect, the UV radiation may decompose the photoinitiators, which may include a number of well-known radiation-sensitive molecules. Then, the decomposed photoinitiators may initiate the polymerization reactions, which create long, often branched, and potentially cross-linked polymeric chains. The polymerization reactions, including the chain lengthening reactions, branching reactions, and cross-linking reactions, generally tend to cause the material to solidify rapidly. Often, depending upon the particular conditions, the material may solidify within a few seconds. Additionally, the approach tends to be economical and tends to be well suited for either small or larger volume manufacturing.

In one embodiment of the invention, the representation of the image may include a dot matrix representation of the image formed by printing with one or more ink-jet spray nozzles. The dot matrix representation of the image may include a pattern of a plurality of dots substantially arranged in a grid. It will be appreciated that the grid may not be perfect. The term substantially arranged in a grid is meant to include at least the amount of deviation from a perfect grid that is customarily expected for a printer of the type used to form the decoration. Each of the plurality of dots may include a solid, polymerized, cross-linked material that may include one or more colored inks.

As the decoration is being applied, the surface being printed on may either move under the ink-jet spray nozzles, or the ink-jet spray nozzles may move over the surface being printed on, as desired. A shuttle bed, a conveyor belt, or other moving bed may pass under a jet where light-activated ink may be applied to decorate at least a portion of the surface being printed on. Alternatively, in another aspect, a mechanism may be employed to lock the surface to be printed on in place and pass the jet over the stationary surface to apply light-activated ink. The printing speed may depend upon the resolution of the digital image. In one embodiment of the invention, when using the UJF-605C Flatbed UV Inkjet Printer of Mimaki, it may be appropriate to employ print speeds of about 200 ft²/hr for 300 dpi, 55 ft²/hr for 600 dpi, and 20 ft²/hr for 1200 dpi.

In one embodiment of the invention, to help increase the quality or appearance of the decoration, a mask may first optionally be printed in a UV curable ink composition over the surface, and then a multi-color image may be printed over the mask in one or more UV curable ink compositions. The mask may be applied over the entire surface, or selectively over portions of the surface that are to receive the multi-color decoration, as desired. In one aspect, the mask may have substantially the same size, shape, and position as the image.

The mask may include a convenient, typically solid, background color. For example, the mask may include a substantially white color. The term substantially white is intended to include off-white colors including yellowish or grayish whites (e.g., ivory). One suitable substantially white UV-curable ink is XaarJet-71W00, available from Xaar plc, of Cambridge, United Kingdom. In one aspect, the mask may include a substantially white UV print primer composition. Other colors, such as gray, blue, or black, for example, may also optionally be employed. Other substantially UV curable ink compositions are available from Mimaki, Durst, and Zund, to name a few.

As previously mentioned, UV printing is not required. Other printing, such as, for example, digital ink jet printing with solvent based inks, are also suitable.

In the case of UV printing, due at least in part to the polymerization or crosslinking, the decoration tends to be quite durable. However, an optional coating may often be formed over the decoration in order to help protect the decoration from wear, and enhance the gloss, sheen, and other visual attributes of the guitar video game controller. The coating is often referred to in the arts as a topcoat. Commonly employed topcoats include polyurethane coatings and lacquer coatings, such as shellac coatings and nitrocellulose coatings. The addition of the cross-linking, protective coatings may make the decoration more durable, so as to withstand years of use and retain its beauty. Also, the guitar or game controller may be cleaned repeatedly without removing or scratching the decoration. Suitable topcoats include, but are not limited to, polyurethane, polyester, polyacrylic, and lacquer coatings. An example is POLANE® High Solids Clear Topcoat brand polyurethane coating, available from The Sherwin-Williams Company, of Cleveland, Ohio. Another example is SHER-W00D® CAB-Acrylic Lacquer brand lacquer from The Sherwin-Williams Company. Yet another example is Lawrence MCFADDEN™ solvent-based nitrocellulose lacquer brand lacquer, available from The Lawrence-McFadden Company, of Philadelphia, Pa. If desired, multiple coats may be used. Then, the topcoat may be buffed to a shine.

In one or more embodiments, a clear resin, such as a “dome label”, may optionally be dispensed or otherwise applied over the decoration either before or after the decoration is applied to the body of the guitar or guitar game controller. Such a resin may be applied using a conventional or substantially conventional dome label formation process or method such as a syringe, optically-guided, automated dispensing equipment, or other dispensing equipment, to dispense the material of the dome label. Once applied, the dome resin or doming material may flows to the edge of the surface on which it is dispensed and stop due in part to surface tension of the liquid and then eventually harden to a dome. The dome may be transparent and may have a three dimensional curved or domed surface. In one or more embodiments, the dome label may include a clear transparent durable material such as vinyl, acrylic, urethane, or the like, that is about 2 mm thick. The dome label may have various hardness. In one particular embodiment, the dome label may include a dome label formed by a DEMAK® brand dome label dispensing system commercially available from Demak America, Inc. of Totowa, N.J., in which a protective clear resin coating is dispensed onto the decoration to provide a three-dimensional thickness. Advantageously, the dome label may provide a glossy look that may resemble the glossy look provided by several coats of urethane or acrylic clear coat traditionally applied to a traditional stringed musical instrument guitar. The dome label may also help to protect the image. In one or more embodiments of the invention, the dome label may optionally have a material with a Shore D hardness in the range of from 60 to 80, or from 63 to 78, or from 65 to 75. One example of a suitable doming resin having a hardness within such ranges is CHEM-DEC™ 895C brand polyurethane doming resin, which is commercially available from Chemque, Inc., of Indianapolis, Ind. and Ontario, Canada. A Shore hardness in this range, especially in the range of from 65 to 75, closely matches the hardness and feel of the outer coatings found on many real guitar (i.e., stringed musical instruments). Such outer coatings are typically formed as multiple coats of clear acrylic, polyurethane, or like materials. Conventional dome labels by way of contrast are typically made of a softer material that would not provide this effect to the player of the guitar or guitar game controller. Such dome labels of such hardness may therefore provide the user with a surface of a hardness and feel that closely matches that of real high end guitars but by using a dome formation approach instead of the laborious and more expensive processes typically used to form the clear coats on high end guitars.

A detailed particular example method, according to an example embodiment of the invention, may include UV printing a decoration on a thin transparent or translucent white sheet of vinyl or another polymeric material. Then the thin sheet having the decoration may be adhered, laminated, or otherwise coupled on an electroluminescent lamp or other light. Then a dome label may be applied over or otherwise coupled over the decoration after it has been applied to the electroluminescent lamp or other light. Then the electroluminescent lamp or other light having the decoration may be adhered or otherwise coupled with the body of a guitar or guitar video game controller having a shape of a body of a guitar.

During use, the electroluminescent lamp or other light may transmit light through the decoration, which may be partially translucent, which may light up the decoration or make it appear to glow or radiate light. Advantageously, this may help to improve the appearance or aesthetics of the decoration. Advantageously, this may help the decoration to be more easily viewed in a dark environment, such as, for example, a bar, nightclub, or the like. The decoration, which in some cases may be an advertisement, may be more easily seen. Advertisers may like this feature since it may promote advertisement of a brand name, product, logo, or the like. It is thought that this may be particularly advantageous for a guitar video game controller when it is played at a bar or nightclub in front of other people for promotional purposes to promote an advertisement in the decoration illuminated by the light or lamp. However, the scope of the invention is not limited to such a use of an advertisement or use in such a setting or environment. Guitar game controllers to be used by end users in home settings as well as regular stringed guitar musical instruments may benefit from the decorations and lights disclosed herein.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. It is to be understood that the above description is intended to be illustrative, and not restrictive. Combinations of the above embodiments, and other embodiments will be apparent to those of skill in the art upon reviewing the above description. The scope of the invention includes any other applications in which the above structures and fabrication methods are used. The scope of the invention should be determined with reference to the appended claims, along with the full scope of equivalents to which such claims are entitled.

In the description above, for the purposes of explanation, numerous specific details have been set forth in order to provide a thorough understanding of the embodiments of the invention. It will be apparent however, to one skilled in the art, that one or more other embodiments may be practiced without some of these specific details. The particular embodiments described are not provided to limit the invention but to illustrate it. The scope of the invention is not to be determined by the specific examples provided above but only by the claims below. In other instances, well-known circuits, structures, devices, and operations have been shown in block diagram form or without detail in order to avoid obscuring the understanding of the description.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other for example through an intervening component.

It will also be appreciated, by one skilled in the art, that modifications may be made to the embodiments disclosed herein, such as, for example, to the sizes, shapes, configurations, forms, functions, materials, and manner of operation, and assembly and use, of the components of the embodiments. All equivalent relationships to those illustrated in the drawings and described in the specification are encompassed within embodiments of the invention.

Various operations and methods have been described. Some of the methods have been described in a basic form, but operations may optionally be added to and/or removed from the methods. The operations of the methods may also often optionally be performed in different order. Many modifications and adaptations may be made to the methods and are contemplated.

It should also be appreciated that reference throughout this specification to “one embodiment”, “an embodiment”, or “one or more embodiments”, for example, means that a particular feature may be included in the practice of the invention. Similarly, it should be appreciated that in the description various features are sometimes grouped together in a single embodiment, Figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

What is claimed is:

1. An apparatus, comprising:
a gaming controller powered by a first power source;
an electroluminescent (EL) lamp coupled to the gaming controller and powered by a second power source, the EL lamp removably coupled to the gaming controller to mask a portion of the gaming controller.

2. The apparatus of claim 1, wherein the EL lamp is laminated to the gaming controller.

3. The apparatus of claim 1, wherein the EL lamp is adhered to the gaming controller.

4. The apparatus of claim 1, wherein the EL lamp is adhered to a plate that is mechanically coupled to the gaming controller.

5. The apparatus of claim 1, wherein the gaming controller comprises a guitar.

6. The apparatus of claim 1, further comprising at least one LED lamp coupled to the gaming controller and powered by the second power source.

7. An system, comprising:
a gaming controller, comprising:
a gaming control circuit to receive inputs and communicate a control signal based on the inputs;
a wireless transceiver to wirelessly communicate the control signal; and
a controller connector to communicate the control signal via wired communications; and
an electroluminescent (EL) system coupled to the gaming controller, comprising:
at least one EL lamp coupled to the gaming controller;
an inverter coupled to the EL lamp to light the EL lamp according to the control signal;
an EL control circuit to control power to the inverter based on the control signal; and
an EL lamp connector coupled to the EL control circuit, and
a connector communicatively coupling the EL lamp connector and the controller connector such that the gaming control circuit is communicatively coupled to the EL control circuit.

8. The system of claim 7, wherein the inverter includes a monitor circuit to monitor capacitance of the EL lamp and to provide an EL lamp capacitance signal, and a compensation circuit to adjust voltage to the EL lamp based on the EL lamp capacitance signal.

9. The system of claim 7, further comprising a power source to power the gaming controller and the EL system, the power source being coupled to the gaming controller.

10. The system of claim 7, further comprising a first power source coupled to the gaming controller to power the gaming controller and a second power source coupled to the EL system to power the EL system.

11. The system of claim 10, further comprising a cradle to connect to the second power source.

12. A method, comprising:
communicating a signal associated with user performance from a gaming console to a gaming controller; and
controlling an electroluminescent (EL) lamp coupled to the gaming controller according to the signal.

13. The method claim 12, further comprising continuously illuminating the EL lamp.

14. The method of claim 12, further comprising blinking the EL lamp.

15. The method of claim 14, further comprising blinking the EL lamp according to the signal.

16. A method of claim 12, wherein controlling includes controlling an EL lamp that includes illuminated and non-illuminated regions having different colors.

17. The method of claim 16, further comprising transmitting light from the EL lamp through a layer that changes the color of the regions.

18. The method of claim 12, wherein controlling the EL lamp according to the signal comprises causing the EL lamp to transmit light through a decoration and a dome label, wherein the decoration comprises a multi-colored dot matrix representation having cross-linked inks.

19. A guitar gaming controller comprising:
a body and a neck, in which the gaming controller is guitar shaped;
a plurality of lamps coupled with the body, the plurality of lamps including a first lamp and a second lamp;
a pattern over the plurality of lamps, in which the plurality of lamps are to transmit light through the pattern;
a plurality of buttons including a first button and a second button, in which the first button when pressed is to illuminate the first lamp and the second button when pressed is to illuminate the second lamp without illuminating the first lamp.

20. The guitar gaming controller of claim 19, wherein the lamp comprises one of an electroluminescent lamp and an LED lamp.

21. The guitar gaming controller of claim 19, wherein the pattern comprises a decoration over at least a majority of a front of the body, and wherein the decoration comprises a multi-colored dot matrix representation.

22. The guitar gaming controller of claim 21, wherein the dot matrix representation comprises cross-linked inks.

23. The guitar gaming controller of claim 21, wherein the decoration comprises an advertisement.

24. The guitar gaming controller of claim 21, further comprising a dome label over the decoration.

25. The guitar gaming controller of claim 24, in which the dome label has a Shore D hardness in a range of 65 to 75.

26. The guitar gaming controller of claim 19, wherein the pattern comprises a decoration, wherein the decoration is over at least a majority of a front of the body, wherein the decoration comprises a multi-colored dot matrix representation having cross-linked inks, and wherein the decoration comprises an advertisement, and further comprising a dome label having a Shore D hardness in a range of 65 to 75 over the decoration.
